(19) United States
(12) Patent Application Publication
(10) Pub. No.: US 2026/0316161 A1
(43) Pub. Date: Oct. 15, 2026

(54) Tail stock of machine tool and method for setting same

(71) Applicant: DN SOLUTIONS CO., LTD., Changwon (KR)

(72) Inventors: Seungpil SEO, Changwon (KR); Sugwang KIM, Changwon (KR)

(21) Appl. No.: 19/484,771

(22) PCT Filed: Apr. 18, 2024
(86) PCT No.: PCT/KR2024/005247

§ 371 Date: Dec. 9, 2025

(30) Foreign Application Priority Data
May 16, 2023 (KR) 10-2023-0062902

(51) Int. Cl. B23B 23/00

(52) U.S. Cl. CPC B23B 23/005; B23B 2260/004; B23B 2270/48

(57) ABSTRACT

The present disclosure relates to a tailstock and a method of setting the same, wherein a forward position of a quill or a backward position of the quill may be easily changed in real time and conveniently set without moving a housing or a sensing unit in accordance with the type of workpiece, thereby reducing the time required for changing setting, minimizing non-processing time, improving productivity, preventing an erroneous operation by means of precise recognition, improving reliability and safety of a machine tool, and enhancing convenience for an operator.

### FIELD OF THE DISCLOSURE

The present disclosure relates to a tailstock and a method of setting the same, and more particularly, to a tailstock and a method of setting the same, wherein a set forward position of a quill or a set backward position of the quill may be easily changed in real time and conveniently set without moving a housing or a sensing unit in accordance with the type of workpiece, thereby reducing the time required for changing setting, minimizing non-processing time, improving productivity, preventing an erroneous operation by means of precise recognition, improving reliability and safety of a machine tool, and enhancing convenience for an operator.

### BACKGROUND OF THE DISCLOSURE

In general, a machine tool refers to a machine used to process metal/non-metal workpieces in a desired shape and dimension using a suitable tool by using various types of cutting or non-cutting methods.

Various types of machine tools including a turning center, a vertical/horizontal machining center, a door-type machining center, a Swiss turning machine, an electric discharge machine, a horizontal NC boring machine, a CNC lathe, and a multi-tasking machining center are being widely used to suit the purpose of the corresponding work in various industrial sites.

The multi-tasking machining center, among the machine tools, refers to a turning center equipped with a multifunctional automatic tool changer (ATC) and a tool magazine in order to perform various types of machining processes such as turning, drilling, tapping, or milling. In the case of the multi-tasking machining center, an operator manually mounts a tool on a tool magazine when loading the tool required for a machining process or changing the tools.

In general, various types of currently used machine tools each have a control panel to which a numerical control (NC) technology or a computerized numerical control (CNC) technology is applied. The control panel is provided with a multifunctional switch or button, and a monitor.

In addition, the machine tool includes a table on which a material, i.e., a workpiece is seated and which transfers the workpiece to machine the workpiece, a palette used to prepare the workpiece to be machined, a spindle coupled to a tool or the workpiece and configured to be rotated, and a tailstock and a steady rest configured to support the workpiece during the machining process.

In general, the machine tool is provided with a transfer unit configured to transfer the table, a tool post, the spindle, the tailstock, and the steady rest along a transfer shaft in order to perform various types of machining processes.

Further, the machine tool generally uses a plurality of tools in order to perform various types of machining processes, and a tool magazine or a turret is used in the form of a tool storage place for receiving and storing the plurality of tools.

The machine tool uses the plurality of tools in order to perform various types of machining processes, and the tool magazine is used in the form of a tool storage place for receiving and storing the plurality of tools.

In addition, the machine tool is generally equipped with the automatic tool changer (ATC) configured to withdraw a specific tool from the tool magazine or remount the tool on the tool magazine based on an instruction of a numerical control unit in order to improve productivity of the machine tool.

Further, the machine tool is generally equipped with an automatic palette changer (APC) in order to minimize the non-machining time. The automatic palette changer (APC) automatically changes the palettes between a workpiece machining region and a workpiece loading region. The workpiece may be mounted on the palette.

In addition, the machine tools are generally classified broadly into a turning center and a machining center depending on machining methods.

In general, a multi-task center (or integrated mill-turn center) refers to a machine tool capable of implementing various machining processes, such as turning, milling, drilling, tapping, and boring, on a workpiece in one machining step utilizing a single machine tool. The use of the multi-task center may improve productivity and precision while reducing lead time, the number of components, workload, workspace, and the like.

With reference to FIGS. 1 to 3, the turning center may include a chuck 17 configured to clamp a workpiece 16, and a tailstock 10 configured to fix a free end of the workpiece 16 clamped by the chuck 17.

The tailstock 10 of the machine tool in the related art is movably disposed in the turning center, supports the free end of the comparatively long workpiece 16, and prevents sagging or buckling of the workpiece 16, thereby improving machining quality.

That is, as illustrated in FIGS. 2 to 3, positions K1 and K2 at which a quill 12 supports the workpieces are changed depending on a difference between lengths L1 and L2 of the workpieces 16 mounted on the chuck 17. As a result, a forward position and a backward position of the quill need to be adjusted.

Specifically, the tailstock 10 of the machine tool in the related art includes a body part 11 and a position adjustment part. The body part 11 includes a quill 12 configured to fix a free end K1 of the workpiece 16, a first sensor 13 configured to sense a forward position M1 that moves forward by a distance corresponding to a distance by which the quill 12 moves forward, a second sensor 14 configured to sense a backward position J1 that moves backward by a distance corresponding to a distance by which the quill moves backward, and a cover 15 detachably mounted on the body part to protect the first sensor 13 and the second sensor 14.

The forward position and the backward position are adjusted so that the first sensor and the second sensor are positioned at positions corresponding to the forward position and the backward position.

In the related art, because the tailstock of the machine tool cannot recognize the forward and backward positions, basic setting of the tailstock needs to be changed, which causes a problem in that an operator is inconvenienced and reliability of the machine tool deteriorates.

In addition, even in case that the tailstock of the machine tool in the related art changes the position of the quill, the tailstock may recognize only the two forward and backward positions. As a result, there is a problem in that precision and machining quality deteriorate, and a machining error of the tailstock or the like cannot be determined, which causes an increase in defect rate.

Moreover, in the case of the tailstock of the machine tool in the related art, two or more bolts need to be unfastened (or the bolts need to be tightened and coupled) to adjust the position sensor. The operator needs to use a wrench to perform the operation of unfastening the two or more bolts (or tightening and coupling the bolts) from below to above. As a result, there is a problem in that a structure of the position adjustment part is complicated, and it is difficult for the operator to unfasten the bolt (or tighten and coupling the bolt) while accurately identifying a position of the bolt. In particular, in the case of middle-scale or small-scale equipment with a small size, a size of the tailstock is small, and a space through which the wrench may approach the bolt from below the bolt to unfasten the bolt (or tighten and couple the bolt), is very narrow, which causes a problem in that the operator has significant difficulty in performing the operation and non-processing time increases.

### DISCLOSURE

### Summary

The present disclosure has been made in an effort to solve the above-mentioned problem, and an object of the present disclosure is to provide a tailstock of a machine tool and a method of setting the same, wherein a set forward position of a quill or a set backward position of the quill may be easily changed in real time and conveniently set without moving a housing or a sensing unit in accordance with the type of workpiece, thereby reducing the time required to change setting, minimizing non-processing time, and improving productivity, and the presence or absence of abnormality may be automatically detected before the workpiece is machined in accordance with the set forward position of the quill or the set backward position of the quill and an actual forward position of the quill or an actual backward position of the quill, to which the quill is actually moved, thereby preventing an erroneous operation by means of precise recognition, improving reliability and safety of the machine tool, and enhancing convenience for an operator.

In order to achieve the above-mentioned object of the present disclosure, a tailstock of a machine tool according to the present disclosure may include: a housing movably installed on a bed; a quill installed on the housing and configured to be movable forward or backward and support a workpiece; a sensing unit configured to recognize a forward position of the quill or a backward position of the quill in real time in all sections wherein the quill moves when the quill moves forward or backward; and a control unit configured to adjust the forward and backward positions of the quill in accordance with the type of workpiece, wherein the control unit changes and sets the forward position of the quill or the backward position of the quill in real time without moving the housing or the sensing unit in accordance with the type of workpiece.

In addition, in another exemplary embodiment of the tailstock of the machine tool according to the present disclosure, the control unit of the tailstock of the machine tool may automatically detect the presence or absence of abnormality before the workpiece is machined in accordance with a set forward position of the quill or a set backward position of the quill and an actual forward position of the quill or an actual backward position of the quill to which the quill is actually moved.

In addition, in another exemplary embodiment of the tailstock of the machine tool according to the present disclosure, the control unit of the tailstock of the machine tool may include: a memory part configured to store data for changing and setting the set forward position of the quill or the set backward position of the quill in real time in accordance with the type of workpiece and detecting in advance the presence or absence of abnormality in accordance with the actual forward position of the quill or the actual backward position of the quill; a selection part configured to select the set forward position and the set backward position of the quill in accordance with the type of workpiece and the data stored in the memory part; a processing part configured to command a movement of the quill to the set forward position of the quill or the set backward position of the quill in accordance with the data stored in the memory part and a selection result of the selection part; and an analysis part configured to analyze the presence or absence of abnormality in accordance with the data stored in the memory part, the selection result of the selection part, and a processing result of the processing part.

In addition, in another exemplary embodiment of the tailstock of the machine tool according to the present disclosure, the memory part of the control unit of the tailstock of the machine tool may include: a basic data storage part configured to store data related to workpiece information, tailstock information, tailstock clamp distance, overall machining region distance, positional error range, and machining program; a position data storage part configured to store data related to the set forward position and the set backward position of the quill for each workpiece; a detection data storage part configured to store data related to a current forward position of the quill or a current backward position of the quill detected by the sensing unit; and a real-time data storage part configured to store the selection result of the selection part, the processing result of the processing part, and an analysis result of the analysis part in real time.

In addition, in another exemplary embodiment of the tailstock of the machine tool according to the present disclosure, the selection part of the control unit of the tailstock of the machine tool may include: a determination portion configured to determine a workpiece, which is to be currently supported by the quill in accordance with the data stored in the basic data storage part or an external command; and a selection portion configured to select the set forward position and the set backward position of the quill based on the workpiece, which is to be currently supported by the quill, in accordance with a determination result of the determination portion and the data stored in the position data storage part.

In addition, in another exemplary embodiment of the tailstock of the machine tool according to the present disclosure, the analysis part of the control unit of the tailstock of the machine tool may include: an identification portion configured to identify the actual forward position of the quill or the actual backward position of the quill by means of the sensing unit and transmit data to the detection data storage part to store the data in the detection data storage part in a state wherein a movement of the quill is completed in accordance with the selection result and the processing result of the processing part; a comparison portion configured to compare the set forward position of the quill or the set backward position of the quill and the actual forward position of the quill or the actual backward position of the quill in accordance with the data stored in the memory part, the selection result of the selection part, and an identification result of the identification portion; and a detection portion configured to automatically detect the presence or absence of abnormality caused by seating of a workpiece or a workpiece defect, before the workpiece is machined, in accordance with the data stored in the basic data storage part and a comparison result of the comparison portion.

In addition, in another exemplary embodiment of the tailstock of the machine tool according to the present disclosure, the detection portion of the control unit of the tailstock of the machine tool may determine that the actual forward position of the quill or the actual backward position of the quill stored in the detection data storage part is normal when the set forward position and the set backward position of the quill according to the selection result of the selection portion are within a positional error range stored in the basic data storage part, and the detection portion may generate an alarm when the set forward position and the set backward position of the quill exceed the positional error range.

In addition, in another exemplary embodiment of the tailstock of the machine tool according to the present disclosure, the sensing unit of the tailstock of the machine tool may recognize, in real time, the forward position of the quill or the backward position of the quill by using a phase difference between square waves or recognize, in real time, the forward position of the quill or the backward position of the quill by using a voltage change made by a megnetic field.

In addition, in another exemplary embodiment of the tailstock of the machine tool according to the present disclosure, the control unit of the tailstock of the machine tool may further include: an option part configured to automatically change and set the set forward position of the quill or the set backward position of the quill in real time without moving the housing or the sensing unit in accordance with the type of workpiece and determine whether to automatically detect the presence or absence of abnormality before machining the workpiece in accordance with the set forward position of the quill or the set backward position of the quill and the actual forward position of the quill or the actual backward position of the quill to which the quill is actually moved; and a display part configured to display results of the memory part, the selection part, the processing part, and the analysis part.

In order to achieve another object of the present disclosure, a method of setting tailstock of a machine tool according to the present disclosure may include: storing data for changing and setting a set forward position of a quill or a set backward position of the quill in real time without moving a housing or a sensing unit in accordance with the type of workpiece and for detecting in advance the presence or absence of abnormality in accordance with an actual forward position of the quill or an actual backward position of the quill; adopting and determining a workpiece to be currently supported by the quill in accordance with pre-stored data; selecting the set forward position and the set backward position of the quill based on the type of workpiece to be currently supported by the quill in accordance with a determination result and the pre-stored data; and performing a command to process a movement of the quill to the set forward position or the set backward position in accordance with the pre-stored data and a selection result.

In addition, in another exemplary embodiment of the method of controlling the tailstock of the machine tool according to the present disclosure, the method of controlling the tailstock of the machine tool may further include: after the performing of the command to process the movement, identifying an actual forward position of the quill or an actual backward position of the quill and transmitting and storing data related to the actual forward position of the quill or the actual backward position of the quill in a state wherein the movement of the quill is completed in accordance with a processing result; comparing the set forward position of the quill or the set backward position of the quill and the actual forward position of the quill or the actual backward position of the quill in accordance with the pre-stored data and an identification result; and automatically detecting the presence or absence of abnormality caused by seating of a workpiece or a workpiece defect before the workpiece is machined in accordance with the pre-stored data and a comparison result.

In addition, in another exemplary embodiment of the method of setting the tailstock of the machine tool according to the present disclosure, the detecting of the presence or absence of abnormality of the method of controlling the tailstock of the machine tool may include: determining that the actual forward position of the quill or the actual backward position of the quill is normal and performing machining when the set forward position and the set backward position of the quill according to the selection result are within a pre-stored positional error range; and generating an alarm when the set forward position and the set backward position of the quill exceed the positional error range.

According to the tailstock of the machine tool and the method of setting the same according to the present disclosure, the set forward position of the quill or the set backward position of the quill may be easily changed in real time and conveniently set without moving the housing or the sensing unit in accordance with the type of workpiece, thereby reducing the time required to change setting, minimizing non-processing time, and improving productivity.

In addition, according to the tailstock of the machine tool and the method of setting the same according to the present disclosure, the presence or absence of abnormality may be automatically detected before the workpiece is machined in accordance with the set forward position of the quill or the set backward position of the quill and the actual forward position of the quill or the actual backward position of the quill, to which the quill is actually moved, thereby preventing an erroneous operation by means of precise recognition, improving reliability and safety of the machine tool, and improving machining quality.

Moreover, according to the tailstock of the machine tool and the method of setting the same according to the present disclosure, the forward position of the quill or the backward position of the quill may be easily changed in real time and conveniently set without moving the housing or the sensing unit in accordance with the type of workpiece, thereby achieving convenience for the operator, and protecting the operator by preventing an injury, such as scratches on the operator's hand, caused by surrounding structures.

### DESCRIPTION OF THE DRAWINGS

FIG. 1 is a conceptual view of a tailstock in the related art before a workpiece is supported.

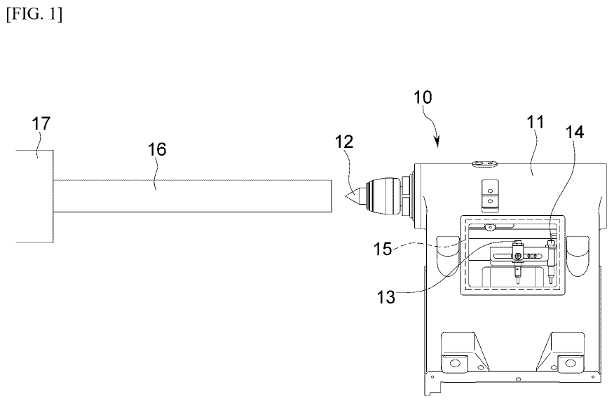

FIG. 2 is a conceptual view of the tailstock in the related art in a state wherein the workpiece is supported.

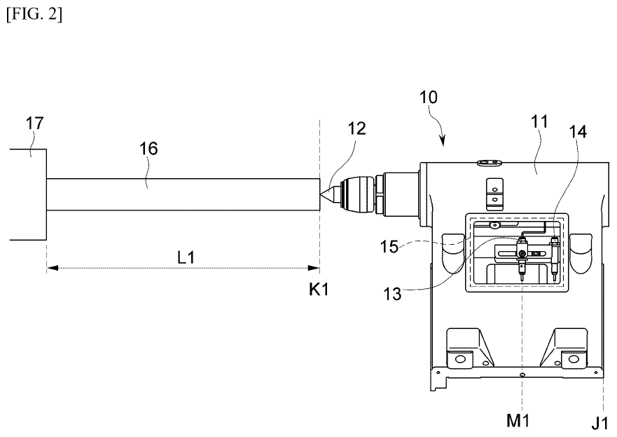

FIG. 3 is a conceptual view of the tailstock in the related art in a state wherein a workpiece having a length different from a length of the workpiece in FIG. 2 is supported.

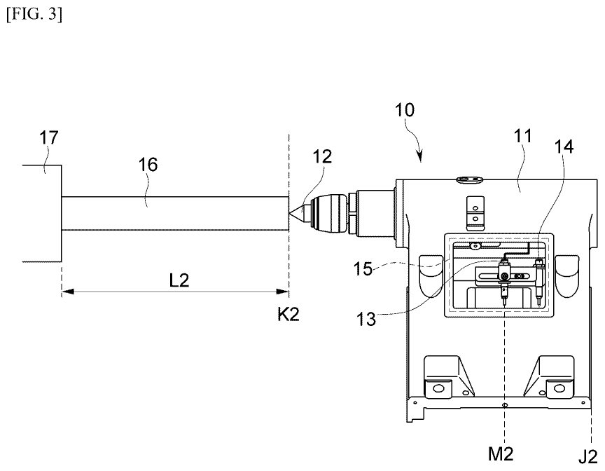

FIG. 4 is a conceptual view of a tailstock according to the present disclosure in a state wherein a workpiece supported.

FIG. 5 is a conceptual view of the tailstock according to the present disclosure in a state wherein a workpiece having a length different from a length of the workpiece in FIG. 4 is supported.

FIG. 6 is a configuration view of a control unit of the tailstock of a machine tool according to the present disclosure.

FIG. 7 is a conceptual view illustrating a configuration for detecting the presence or absence of abnormality of the tailstock of the machine tool according to the present disclosure.

FIG. 8 is a conceptual view of a tailstock setting screen of the machine tool according to the present disclosure.

FIG. 9 is a flowchart of a method of setting the tailstock of the machine tool according to the present disclosure.

### DETAILED DESCRIPTION OF CERTAIN INCENTIVE EMBODIMENT

Hereinafter, a tailstock of a machine tool and a method of setting the same according to the embodiment of the present disclosure will be described in detail with reference to the drawings. The following exemplary embodiments are provided as examples for fully transferring the spirit of the present disclosure to those skilled in the art. Therefore, the present disclosure is not limited to the exemplary embodiments described below and may be specified as other aspects. Further, in the drawings, a size and a thickness of the apparatus may be exaggerated for convenience. Like reference numerals indicate like constituent elements throughout the specification.

Advantages and features of the present disclosure and methods of achieving the advantages and features will be clear with reference to exemplary embodiments described in detail below together with the accompanying drawings. However, the present disclosure is not limited to the exemplary embodiments disclosed herein but will be implemented in various forms. The exemplary embodiments of the present disclosure are provided so that the present disclosure is completely disclosed, and a person with ordinary skill in the art can fully understand the scope of the present disclosure. The present disclosure will be defined only by the scope of the appended claims. Like reference numerals indicate like constituent elements throughout the specification. In the drawings, sizes and relative sizes of layers and regions may be exaggerated for clarity of description.

The terms used in the present specification are for explaining the exemplary embodiments, not for limiting the present disclosure. Unless particularly stated otherwise in the present specification, a singular form also includes a plural form. The terms “comprise (include)” and/or “comprising (including)” used in the specification are intended to specify the presence of the mentioned constituent elements, steps, operations, and/or elements, but do not exclude presence or addition of one or more other constituent elements, steps, operations, and/or elements.

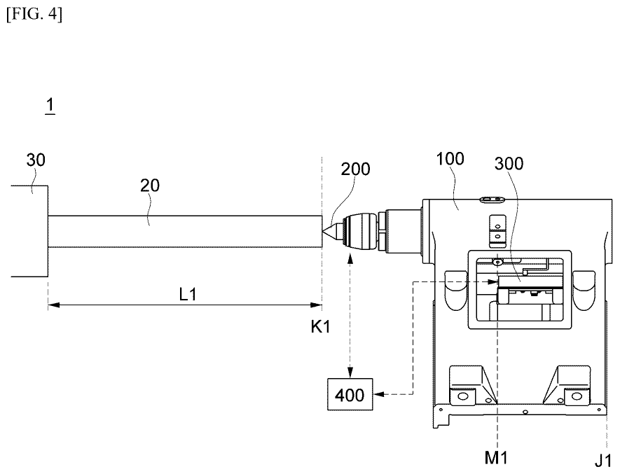

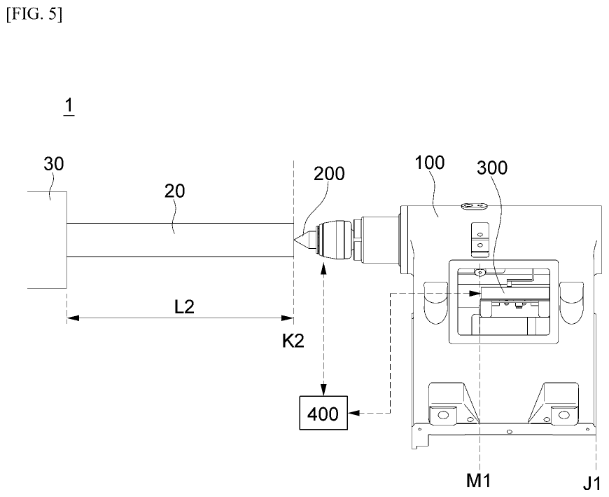

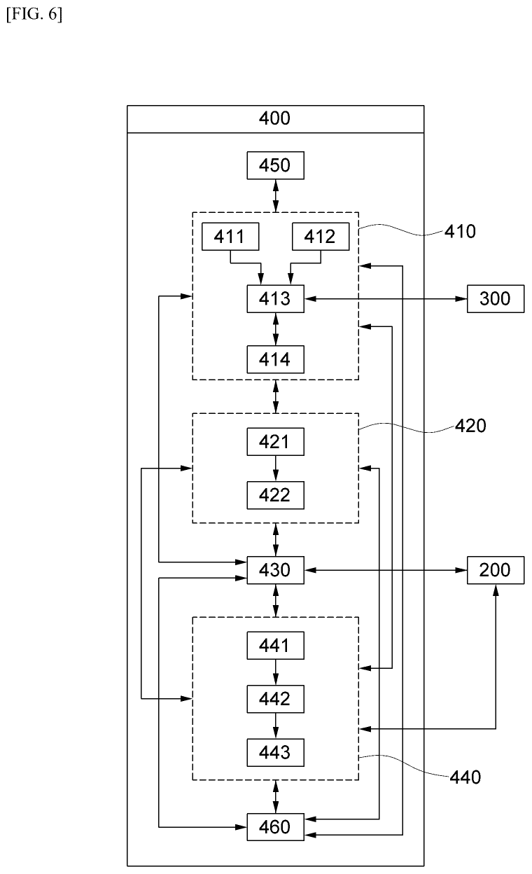

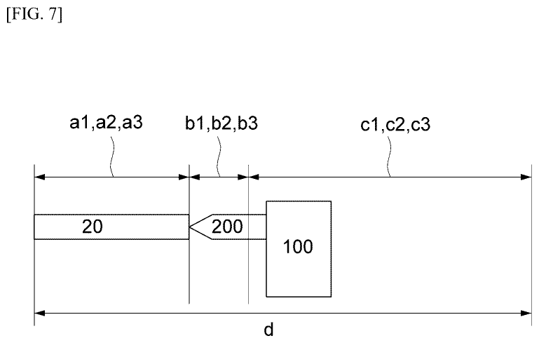

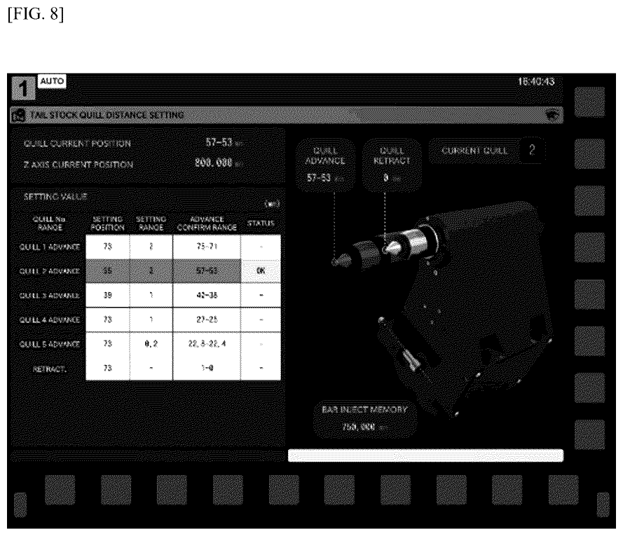

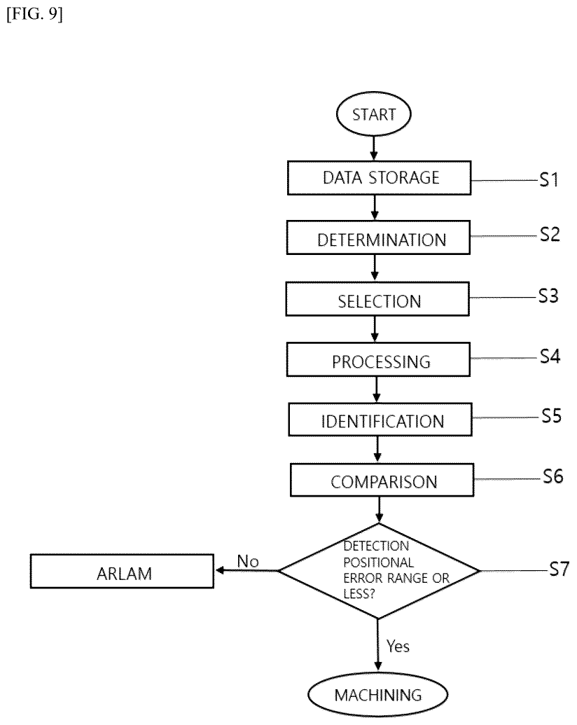

FIG. 4 is a conceptual view of a tailstock according to the present disclosure in a state wherein a workpiece supported. FIG. 5 is a conceptual view of the tailstock according to the present disclosure in a state wherein a workpiece having a length different from a length of the workpiece in FIG. 4 is supported. FIG. 6 is a configuration view of a control unit of the tailstock of a machine tool according to the present disclosure. FIG. 7 is a conceptual view illustrating a configuration for detecting the presence or absence of abnormality of the tailstock of the machine tool according to the present disclosure. FIG. 8 is a conceptual view of a tailstock setting screen of the machine tool according to the present disclosure. FIG. 9 is a flowchart of a method of setting the tailstock of the machine tool according to the present disclosure.

A tailstock 1 of a machine tool according to the present disclosure will be described with reference to FIGS. 4 to 8. The tailstock 1 of the machine tool according to the present disclosure includes a housing 100, a quill 200, a sensing unit 300, and a control unit 400.

The housing 100 is movably installed on a bed and defines an overall external shape of the tailstock.

The quill 200 is installed on the housing and configured to be movable forward or backward and support a workpiece. That is, one side of a comparatively long workpiece 20 may be clamped and fixed by a chuck 30, and a free end of the other side of the workpiece 20 may be supported by the quill 200, such that sagging or buckling of the workpiece 20 may be prevented, thereby improving machining quality.

The sensing unit 300 recognizes a forward position M1 of the quill or a backward position J1 of the quill in real time in all sections wherein the quill moves when the quill moves forward or backward.

The sensing unit may recognize, in real time, the forward position of the quill or the backward position of the quill by using a phase difference between square waves or recognize, in real time, the forward position of the quill or the backward position of the quill by using a voltage change made by a magnetic field. Therefore, it is possible to achieve miniaturization of the machine tool.

The control unit 400 adjusts the forward position and the backward position of the quill in accordance with the type of workpiece. The control unit includes numerical control (NC) or computerized numerical control (CNC) and is embedded with various types of numerical control programs.

The control unit may change and set, in real time, the forward position of the quill or the backward position of the quill without moving the housing or the sensing unit in accordance with the type of workpiece.

As described above, in the case of the tailstock of the machine tool according to the present disclosure, the set forward position of the quill or the set backward position of the quill may be easily changed in real time and conveniently set by the control unit without moving the housing or the sensing unit in accordance with the type of workpiece, thereby reducing the time required to change setting, minimizing non-processing time, and improving productivity.

In addition, the control unit may automatically detect the presence or absence of abnormality before machining the workpiece in accordance with the set forward position of the quill or the set backward position of the quill and an actual forward position of the quill or an actual backward position of the quill to which the quill is actually moved.

As described above, in the case of the tailstock of the machine tool according to the present disclosure, the presence or absence of abnormality may be automatically detected before the workpiece is machined in accordance with the set forward position of the quill or the set backward position of the quill and the actual forward position of the quill or the actual backward position of the quill, to which the quill is actually moved, thereby preventing an erroneous operation by means of precise recognition, improving reliability and safety of the machine tool, and improving machining quality.

As illustrated in FIGS. 4 to 8, the control unit 400 of the tailstock of the machine tool according to the present disclosure includes a memory part 410, a selection part 420, a processing part 430, an analysis part 440, an option part 450, and a display part 460.

The option part 460 may automatically change and set the set forward position of the quill or the set backward position of the quill in real time without moving the housing or the sensing unit in accordance with the type of workpiece and determine whether to automatically detect the presence or absence of abnormality before machining the workpiece in accordance with the set forward position of the quill or the set backward position of the quill and the actual forward position of the quill or the actual backward position of the quill to which the quill is actually moved.

Specifically, the option part may be formed in the shape of a button on the display part or the like and allow a user to easily change and conveniently set the forward position of the quill or the backward position of the quill in real time by means of a button manipulation without moving the housing or the sensing unit in accordance with the type of workpiece and automatically detect the presence or absence of abnormality before machining the workpiece in accordance with the set forward position of the quill or the set backward position of the quill and the actual forward position of the quill or the actual backward position of the quill to which the quill is actually moved.

The display part 460 displays results of the memory part, the selection part, the processing part, and the analysis part.

The display part 460 may include at least one of a liquid crystal display (LCD), a thin-film transistor liquid crystal display (TFT LCD), an organic light-emitting diode display (OLED display), a flexible display, a 3D display, and an e-ink display.

In addition, the display part 460 may be provided in the form of a touch screen that may receive various types of data or the user's operation instruction for easily changing and conveniently setting the forward position of the quill or the backward position of the quill in real time without moving the housing or the sensing unit in accordance with the type of workpiece and output the received operation instruction or the resulting information to a numerical controller, PLC, and the control unit. However, the present disclosure is not necessarily limited thereto.

In addition, the display part 450 includes a screen display program and a data input program in accordance with a selection of a screen display and performs a function of displaying a software switch on a display screen in accordance with an output of the screen display program and a function of recognizing an ON/OFF state of the software switch and making an instruction about an input and an output for an operation of the machine.

The memory part 410 stores data for changing and setting the set forward position of the quill or the set backward position of the quill in real time without moving the housing or the sensing unit in accordance with the type of workpiece and stores data for detecting, in advance, the presence or absence of abnormality in accordance with the actual forward position of the quill or the actual backward position of the quill.

The selection part 420 selects the set forward position and the set backward position of the quill in accordance with the type of workpiece and the data stored in the memory part.

The processing part 430 commands the movement of the quill to the set forward position of the quill or the set backward position of the quill in accordance with the data stored in the memory part and the selection result of the selection part.

The analysis part 440 analyzes the presence or absence of abnormality in accordance with the data stored in the memory part, the selection result of the selection part, and the processing result of the processing part.

As illustrated in FIG. 6, the memory part 410 of the control unit of the tailstock of the machine tool according to the present disclosure includes a basic data storage part 411, a position data storage part 412, a detection data storage part 413, and a real-time data storage part 414.

The basic data storage part 411 stores data related to workpiece information, tailstock information, tailstock clamp distances, overall machining region distances, positional error ranges, and machining programs.

The position data storage part 412 stores data related to the set forward position and the set backward position of the quill for each workpiece.

The detection data storage part 413 stores data related to a current forward position of the quill or a current backward position of the quill detected by the sensing unit.

The real-time data storage part 414 stores the selection result of the selection part, the processing result of the processing part, and the analysis result of the analysis part in real time.

As illustrated in FIG. 6, the selection part 420 of the control unit of the tailstock of the machine tool according to the present disclosure includes a determination portion 421 and a selection portion 422.

The determination portion 421 determines a workpiece that needs to be currently supported by the quill based on the data stored in the basic data storage part or an external command.

That is, the determination portion serves to determine a workpiece, which needs to be supported by the quill, based on a machining program or a process program of the data stored in the basic data storage part, an external command of the operator, or another external command because the single machine tool machines various workpieces.

The selection portion 422 selects the set forward position and the set backward position of the quill based on the type of workpiece, which needs to be currently supported by the quill, in accordance with the determination result of the determination portion and the data stored in the position data storage part.

As illustrated in FIG. 6, the analysis part 440 of the control unit of the tailstock of the machine tool according to the present disclosure includes an identification portion 441, a comparison portion 442, and a detection portion 443.

The identification portion 441 identifies the actual forward position of the quill or the actual backward position of the quill by means of the sensing unit and transmits data to the detection data storage part to store the data in the detection data storage part in a state wherein the movement of the quill is completed in accordance with the selection result and the processing result of the processing part.

The comparison portion 442 compares the set forward position of the quill or the set backward position of the quill with the actual forward position of the quill or the actual backward position of the quill in accordance with the data stored in the memory part, the selection result of the selection part, and the identification result of the identification portion.

The detection portion 443 automatically detects the presence or absence of abnormality caused by the seating of the workpiece or a workpiece defect, before the workpiece is machined, in accordance with the data stored in the basic data storage part and the comparison result of the comparison portion.

In addition, the detection portion determines that the actual forward position of the quill or the actual backward position of the quill stored in the detection data storage part is normal in case that the set forward position and the set backward position of the quill according to the selection result of the selection portion are within a positional error range stored in the basic data storage part. The detection portion generates an alarm in case that the set forward position and the set backward position of the quill exceed the positional error range.

The setting of the tailstock of the machine tool and the method of setting the same according to the present disclosure and the principle of determining the presence or absence of abnormality will be described with reference to FIGS. 4 to 8.

As illustrated in FIG. 7, a machining region distance d of the machine tool is stored in advance in the basic data storage part. In addition, distances a1, a2, and a3 with respect to the workpiece 20 are also stored in advance in the basic data storage part. Tailstock movement distances c1, c2, and c3, by which the tailstock 100 may move on the bed, are also stored in the basic data storage part. Quill movement distances b1, b2, and b3, which are obtained by calculating a forward distance and a backward distance of the quill for each workpiece, are stored in the position data storage part.

In addition, electric current values, which are measured based on the detection data, and distances, which are converted based on the electric current value, are stored in the detection data storage part.

The stored data are displayed by the display part of the control unit, as illustrated in FIG. 8, such that the operator may intuitively identify the stored data.

As a result, as illustrated in FIG. 7, the machining region distance d in the machine tool is calculated by adding up the distances a1, a2, and a3 with respect to the workpiece, the quill movement distances b1, b2, and b3, and the tailstock movement distances c1, c2, and c3 (d=a+b+c).

That is, the comparison portion derives the occurrence of an error by comparing the set forward position of the quill or the set backward position of the quill and the actual forward position of the quill or the actual backward position of the quill by using the above-mentioned equation.

Thereafter, the detection portion determines that the actual forward position of the quill or the actual backward position of the quill stored in the detection data storage part is normal in case that the set forward position and the set backward position of the quill according to the selection result of the selection portion are within the positional error range stored in the basic data storage part. The detection portion generates an alarm in case that the set forward position and the set backward position of the quill exceed the positional error range.

According to the tailstock of the machine tool according to the present disclosure, the set forward position of the quill or the set backward position of the quill may be easily changed in real time and conveniently set without moving the housing or the sensing unit in accordance with the type of workpiece, thereby reducing the time required to change setting, minimizing non-processing time, and improving productivity, and the presence or absence of abnormality may be automatically detected before the workpiece is machined in accordance with the set forward position of the quill or the set backward position of the quill and the actual forward position of the quill or the actual backward position of the quill, to which the quill is actually moved, thereby preventing an erroneous operation by means of precise recognition, improving reliability and safety of the machine tool, and improving machining quality.

The method of setting the tailstock of the machine tool according to the present disclosure will be described with reference to FIG. 9. As illustrated in FIG. 9, the method of setting the tailstock of the machine tool according to the present disclosure includes a data storage step S1, a determination step S2, a selection step S3, a processing step S4, an identification step S5, a comparison step S6, and a detection step S7.

The overall operational principle, the control method, the equipment configuration, and the like of the method of setting the tailstock of the machine tool according to the present disclosure are identical to those of the above-mentioned tailstock of the machine tool according to the present disclosure. Therefore, the following description will focus on the difference.

The data for changing and setting the forward position of the quill or the backward position of the quill in real time without moving the housing or the sensing unit in accordance with the type of workpiece are stored, and data for detecting, in advance, the presence or absence of abnormality in accordance with the actual forward position of the quill or the actual backward position of the quill are stored.

After the data storage step S1, the workpiece, which needs to be currently supported by the quill, is adopted and determined based on the pre-stored data.

After the determination step S2, the set forward position and the set backward position of the quill are selected based on the type of workpiece, which needs to be currently supported by the quill, in accordance with the determination result and the pre-stored data.

After the selection step S3, a command is made to move the quill to the set forward position or the set backward position in accordance with the pre-stored data and the selection result.

After the processing step S4, the actual forward position of the quill or the actual backward position of the quill is identified, and the data related to the actual forward position of the quill or the actual backward position of the quill are transmitted and stored in a state wherein the movement of the quill is completed in accordance with the processing result.

After the identification step S5, the set forward position of the quill or the set backward position of the quill and the actual forward position of the quill or the actual backward position of the quill are compared in accordance with the pre-stored data and the identification result.

After the comparison step S6, the presence or absence of abnormality caused by the seating of the workpiece or a workpiece defect is automatically detected, before the workpiece is machined, in accordance with the pre-stored data and the comparison result.

In the detection step S7, the machining is performed in case that the actual forward position of the quill or the actual backward position of the quill is determined to be normal in case that the set forward position and the set backward position of the quill according to the selection result are within the pre-stored positional error range. An alarm is generated in case that the set forward position and the set backward position of the quill exceed the positional error range.

As described above, according to the method of setting the tailstock of the machine tool according to the present disclosure, the forward position of the quill or the backward position of the quill may be easily changed in real time and conveniently set without moving the housing or the sensing unit in accordance with the type of workpiece, thereby reducing the time required to change setting, minimizing non-processing time, and improving productivity, and the presence or absence of abnormality may be automatically detected before the workpiece is machined in accordance with the set forward position of the quill or the set backward position of the quill and the actual forward position of the quill or the actual backward position of the quill, to which the quill is actually moved, thereby preventing an erroneous operation by means of precise recognition, improving reliability and safety of the machine tool, improving machining quality, achieving convenience for the operator, and protecting the operator by preventing an injury, such as scratches on the operator's hand, caused by surrounding structures.

While the present disclosure has been described above with reference to the exemplary embodiments of the present disclosure in the detailed description of the present disclosure, it may be understood, by those skilled in the art or those of ordinary skill in the art, that the present disclosure may be variously modified and changed without departing from the spirit and scope of the present disclosure disclosed in the claims. Accordingly, the technical scope of the present disclosure should not be limited to the contents disclosed in the detailed description of the specification but should be defined only by the claims.

### DESCRIPTION OF MAIN REFERENCE NUMERALS OF DRAWINGS

1: Tailstock
100: Housing
200: Quill
300: Sensing unit
400: Control unit

1. A tailstock of a machine tool, the tailstock comprising:
a housing movably installed on a bed;
a quill installed on the housing and configured to be movable forward or backward and support a workpiece;
a sensing unit configured to recognize a forward position of the quill or a backward position of the quill in real time in all sections wherein the quill moves when the quill moves forward or backward; and
a control unit configured to adjust the forward and backward positions of the quill in accordance with the type of workpiece,
wherein the control unit changes and sets the forward position of the quill or the backward position of the quill in real time without moving the housing or the sensing unit in accordance with the type of workpiece.

2. The tailstock of claim 1, wherein the control unit automatically detects the presence or absence of abnormality before the workpiece is machined in accordance with a set forward position of the quill or a set backward position of the quill and an actual forward position of the quill or an actual backward position of the quill to which the quill is actually moved.

3. The tailstock of claim 2, wherein the control unit comprises:
a memory part configured to store data for changing and setting the set forward position of the quill or the set backward position of the quill in real time in accordance with the type of workpiece and detecting in advance the presence or absence of abnormality in accordance with the actual forward position of the quill or the actual backward position of the quill;
a selection part configured to select the set forward position and the set backward position of the quill in accordance with the type of workpiece and the data stored in the memory part;
a processing part configured to command a movement of the quill to the set forward position of the quill or the set backward position of the quill in accordance with the data stored in the memory part and a selection result of the selection part; and
an analysis part configured to analyze the presence or absence of abnormality in accordance with the data stored in the memory part, the selection result of the selection part, and a processing result of the processing part.

4. The tailstock of claim 3, wherein the memory part comprises:
a basic data storage part configured to store data related to workpiece information, tailstock information, tailstock clamp distance, overall machining region distance, positional error range, and machining program;
a position data storage part configured to store data related to the set forward position and the set backward position of the quill for each workpiece;
a detection data storage part configured to store data related to a current forward position of the quill or a current backward position of the quill detected by the sensing unit; and
a real-time data storage part configured to store the selection result of the selection part, the processing result of the processing part, and an analysis result of the analysis part in real time.

5. The tailstock of claim 4, wherein the selection part comprises:
a determination portion configured to determine a workpiece, which is to be currently supported by the quill in accordance with the data stored in the basic data storage part or an external command; and
a selection portion configured to select the set forward position and the set backward position of the quill based on the workpiece, which is to be currently supported by the quill, in accordance with a determination result of the determination portion and the data stored in the position data storage part.

6. The tailstock of claim 5, wherein the analysis part comprises:
an identification portion configured to identify the actual forward position of the quill or the actual backward position of the quill by means of the sensing unit and transmit data to the detection data storage part to store the data in the detection data storage part in a state wherein a movement of the quill is completed in accordance with the selection result and the processing result of the processing part;
a comparison portion configured to compare the set forward position of the quill or the set backward position of the quill and the actual forward position of the quill or the actual backward position of the quill in accordance with the data stored in the memory part, the selection result of the selection part, and an identification result of the identification portion; and
a detection portion configured to automatically detect the presence or absence of abnormality caused by seating of a workpiece or a workpiece defect, before the workpiece is machined, in accordance with the data stored in the basic data storage part and a comparison result of the comparison portion.

7. The tailstock of claim 6, wherein the detection portion determines that the actual forward position of the quill or the actual backward position of the quill stored in the detection data storage part is normal when the set forward position and the set backward position of the quill according to the selection result of the selection portion are within a positional error range stored in the basic data storage part, and the detection portion generates an alarm when the set forward position and the set backward position of the quill exceed the positional error range.

8. The tailstock of claim 2, wherein the sensing unit recognizes, in real time, the forward position of the quill or the backward position of the quill by using a phase difference between square waves or recognizes, in real time, the forward position of the quill or the backward position of the quill by using a voltage change made by a magnetic field.

9. The tailstock of claim 3, wherein the control unit further comprises:
an option part configured to automatically change and set the set forward position of the quill or the set backward position of the quill in real time without moving the housing or the sensing unit in accordance with the type of workpiece and determine whether to automatically detect the presence or absence of abnormality before machining the workpiece in accordance with the set forward position of the quill or the set backward position of the quill and the actual forward position of the quill or the actual backward position of the quill to which the quill is actually moved; and
a display part configured to display results of the memory part, the selection part, the processing part, and the analysis part.

10. A method of setting a tailstock of a machine tool, the method comprising:
storing data for changing and setting a set forward position of a quill or a set backward position of the quill in real time without moving a housing or a sensing unit in accordance with the type of workpiece and for detecting in advance the presence or absence of abnormality in accordance with an actual forward position of the quill or an actual backward position of the quill;
adopting and determining a workpiece to be currently supported by the quill in accordance with pre-stored data;
selecting the set forward position and the set backward position of the quill based on the workpiece to be currently supported by the quill in accordance with a determination result and the pre-stored data; and
performing a command to process a movement of the quill to the set forward position or the set backward position in accordance with the pre-stored data and a selection result.

11. The method of claim 10, further comprising:
after the performing of the command to process the movement, identifying an actual forward position of the quill or an actual backward position of the quill and transmitting and storing data related to the actual forward position of the quill or the actual backward position of the quill in a state wherein the movement of the quill is completed in accordance with a processing result;
comparing the set forward position of the quill or the set backward position of the quill and the actual forward position of the quill or the actual backward position of the quill in accordance with the pre-stored data and an identification result; and
automatically detecting the presence or absence of abnormality caused by seating of a workpiece or a workpiece defect before the workpiece is machined in accordance with the pre-stored data and a comparison result.

12. The method of claim 11, wherein the detecting of the presence or absence of abnormality comprises:
determining that the actual forward position of the quill or the actual backward position of the quill is normal and performing machining when the set forward position and the set backward position of the quill according to the selection result are within a pre-stored positional error range; and
generating an alarm when the set forward position and the set backward position of the quill exceed the positional error range.
